(19) United States
(12) Patent Application Publication
(10) Pub. No.: US 2015/0310692 A1
(43) Pub. Date: Oct. 29, 2015

(54) RETAIL AUTOMATION PLATFORM

(71) Applicant: Integrated Technologies Group Corp., Miami, FL (US)

(72) Inventors: Gonzalo Almada, Miami, FL (US); Carlos Lerena, Miami, FL (US)

(21) Appl. No.: 14/694,755

(22) Filed: Apr. 23, 2015

Related U.S. Application Data
(60) Provisional application No. 61/984,034, filed on Apr. 24, 2014.

(51) Int. Cl. G07F 7/08

(52) U.S. Cl. CPC G07F 7/08

(57) ABSTRACT

A platform for retail automation may be provided. The platform may comprise methods, systems, apparatuses, and computer-readable medium configured to perform a method. The method may comprise displaying, to a customer via a touchscreen display disposed at a lounge of a retail station, information regarding a plurality of products stored in a storage area of the retail station; receiving, from the customer via the touchscreen display, input corresponding to selection of a selected product of the plurality of products; reading, by a card reader disposed at the retail station, a card provided by the customer; effecting payment for the selected product utilizing the read card; and automatically effecting movement of, via robotic apparatus, the selected product from the storage area to a dispensing area of the retail station.

### RELATED APPLICATION

Under provisions of 35 U.S.C. § 119(e), the Applicant claims the benefit of U.S. provisional application no. 61/984,034, filed on Apr. 24, 2014 in the name of the same inventors, under the obligation of assignment to the Applicant. The priority application is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to point-of-sale commerce automation methods and systems.

### BACKGROUND

The point-of-sale (POS) is the time and place where a retail transaction is completed. It is the point at which a customer makes a payment to the merchant in exchange for goods or after provision of a service. The POS in various retail situations would use customized hardware and software tailored to their particular requirements. In fact, the retailing industry is one of the predominant users of POS terminals.

A retail point of sale system typically includes a cash register (which in recent times comprises a computer, monitor, cash drawer, receipt printer, customer display and a barcode scanner) and the majority of retail POS systems also include a debit/credit card reader.

The POS unit handles the sales to the consumer but it is only one part of the entire POS system used in a retail business. “Back-office” computers typically handle other functions of the POS system such as inventory control, purchasing, receiving and transferring of products to and from other locations. Other typical functions of a POS system are to store sales information for enabling customer returns, reporting purposes, sales trends and cost/price/profit analysis. Customer information may be stored for receivables management, marketing purposes and specific buying analysis.

Conventional POS technology does not enable retailers to automate the shopping, purchase, and delivery process accompanying the consumer's retail experience. Rather, conventional POS technology only facilitates the transactional process once the shopping and product acquisition have been manually performed by the consumer. This requires, among many other limitations, the retailer to grant its patrons physical access to its inventory (hereinafter referred to as the “retail area”). In turn, the patron must physically navigate and search through the retail area, manually retrieve the desired inventory, and proceed to the POS portion of the store-front for purchasing the retrieved inventory, During this process, the consumer may call upon the retailers human resource for assistance in navigation, questions about inventory offers and pricing, as well as re-organization of disorganized consumer re-shelving of unpurchased inventory.

To facilitate an optimal consumer experience, one which is mutually beneficial to the retailer, retailers have invested considerably in the study and organization of their physically accessible inventory layout. For example, a retailer may arrange promotional offers throughout the inventory, carefully placing promotional products in high-traffic areas, or spontaneously purchased products near the POS portion of the retail area. Nevertheless, these solutions do not address the retailer's pain point of human resource and merchandizing expenditures. Further still, such conventional solutions do not address the consumer's desire to engage in a more convenient and efficient retail experience.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The present disclosure generally relates to systems and methods for providing retail shopping experiences to customers. In particular, the present disclosure seeks to integrate the conventional online shopping experience with the conventional brick-and-mortar store shopping experience in new and novel ways for providing overall enhanced retail shopping experiences to customers.

A need is perceived to provide a retail concept that integrates the best learnings and experiences of both online and brick-and-mortar worlds, both online and offline.

A further need is perceived to provide automated retailing via a new concept store in which customers can shop and experience everything by themselves without interacting with sales persons, sales associates, or retail clerks. A further need is perceived to provide a retail concept store in which the customer uses online technology to select, order and pay for the product, but with the benefit that customer receives the product right away. Accordingly, embodiments of the present disclosure provide a retail automation platform. The platform may be comprised of, but not limited to, a combination of various methods, systems, apparatuses, and computer-readable mediums.

For example, embodiments of the present disclosure may relate to a method for providing a retail automation platform reading, by a first card reader disposed proximate an access point to a retail station, a first card provided by a customer; opening, based on the reading of the first card, the access point to the retail station; displaying, to the customer via a touchscreen display disposed at the retail station, information regarding a plurality of products stored in a storage area; receiving, from the customer via the touchscreen display, input corresponding to selection of a selected product of the plurality of products; reading, by a second card reader disposed at the retail station, a second card provided by the customer, and effecting payment for the selected product utilizing the read second card; automatically effecting movement of, via robotic apparatus, the selected product from the storage area to a dispensing area of the retail station.

The aforementioned embodiments may comprise a retail station located at, for example, but not limited to, an airport, a retail store, a shopping mall, a hotel. Furthermore, the first card used to may be the same as the second card in some embodiments, while different cards in other embodiments. The cards may comprise a credit card, a loyalty or reward card, a gift card, an identification card, a debit card, a credit. Accordingly, the card readers may be configured to read any card-type and provide corresponding authentication. A printing means (e.g., a thermal printer) may also be provided for printing. In this way, a receipt and other product or transactional documentation may be printed.

Consistent with embodiments, the card readers may be disposed adjacent to the access point. The access point may comprise, for example, a sliding door, which may be a glass door. In general, the access point may comprise glass.

Still consistent with embodiments, a touchscreen display may be configured to display, to the customer information regarding a plurality of products stored in a storage area via a multimedia means including, but not limited to, for example, displaying a video (which may be limited or unlimited in time duration), at least one photograph, at least one images, and three-dimensional (3D) renderings of products which may interface with the customer to allow for 3D rendering manipulation (e.g., via a computing input device which may include, but not be limited to, for example, a gesture detection mechanism). The displayed information may further comprise a written discretion of a product. Further still, embodiments may enable a capturing of surveillance video of the retail station, via, for example, a camera used for surveillance. Moreover, embodiments of the present disclosure may comprise a lounge area having one more pieces of comfortable furniture, including, for example, but not limited to a comfortable couch or chairs, an audio system (speakers which may be arranged to create a surround sound environment). The area may comprise room to dispose rolling luggage.

Embodiments of the present disclosure may further relate to a method for providing a retail automation platform reading, by a first card reader disposed at a retail store, a first card provided by a customer; opening, based on the reading of the first card, an access point to a browsing area of the retail store; displaying, to the customer via a touchscreen display disposed in the browsing area, information regarding a plurality of products stored in a warehouse area of the retail store; receiving, from the customer via the touchscreen display, input corresponding to selection of a selected product of the plurality of products; reading, by a second card reader disposed in the browsing area, a second card provided by the customer, and effecting payment for the selected product utilizing the read second card; automatically effecting movement of, via robotic apparatus disposed at the retail store, the selected product from the warehouse area of the retail store to a dispensing area of the browsing area of the retail store.

In accordance to the various embodiments, automatically effecting movement of, via robotic apparatus disposed at the retail store, the selected product from the warehouse area of the retail store to a dispensing area of the browsing area of the retail store comprises movement of the selected product via a robotic arm.

In accordance to the various embodiments, automatically effecting movement of, via robotic apparatus disposed at the retail store, the selected product from the warehouse area of the retail store to a dispensing area of the browsing area of the retail store comprises movement of a movable tray.

In accordance to the various embodiments, automatically effecting movement of, via robotic apparatus disposed at the retail store, the selected product from the warehouse area of the retail store to a dispensing area of the browsing area of the retail store comprises use of an elevator which receives the product and facilitates its movement to the dispensing area of the browsing area.

In accordance to the various embodiments, the dispensing area of the browsing area comprises a dispensing box.

In accordance to the various embodiments, the method further includes capturing, via a surveillance camera, video of the browsing area.

Yet further embodiments of the present disclosure relate to a method for providing a retail automation platform reading, by a first card reader disposed at a retail store, a first card provided by a customer; opening, based on the reading of the first card, an access point to a browsing area of the retail store; displaying, to the customer via a touchscreen display disposed in the browsing area, information regarding a plurality of products stored in a warehouse area of the retail store; receiving, from the customer via the touchscreen display, input corresponding to selection of a selected product of the plurality of products; reading, by a second card reader disposed in the browsing area, a second card provided by the customer, and effecting payment for the selected product utilizing the read second card; automatically effecting movement of, via apparatus disposed at the retail store, the selected product from the warehouse area of the retail store to a dispensing area of the browsing area of the retail store.

Still consistent with embodiments of the present disclosure, a method for automated retail may be provided. The method may comprise displaying, to a customer via a touchscreen display disposed in a browsing area of a retail store, information regarding a plurality of products stored in a warehouse area of the retail store; receiving, from the customer via the touchscreen display, input corresponding to selection of a selected product of the plurality of products; reading, by a card reader disposed in the browsing area, a card provided by the customer, and effecting payment for the selected product utilizing the read card; and automatically effecting movement of, via robotic apparatus disposed at the retail store, the selected product from the warehouse area of the retail store to a dispensing area of the browsing area of the retail store.

Embodiments of the present disclosure may further relate to a method for providing a retail automation platform displaying, to a customer via a touchscreen display disposed in a browsing area of a retail store, information regarding a plurality of products stored in a warehouse area of the retail store; receiving, from the customer via the touchscreen display, input corresponding to selection of a selected product of the plurality of products; reading, by a card reader disposed in the browsing area, a card provided by the customer, and effecting payment for the selected product utilizing the read card; and automatically effecting movement of, via apparatus disposed at the retail store, the selected product from the warehouse area of the retail store to a dispensing area of the browsing area of the retail store.

Further still, embodiments of the present disclosure may relate to a method for providing a retail automation platform reading, by a first card reader disposed adjacent a first access point into a first browsing area of a retail store, a first card provided by a first customer; opening, based on the reading of the first card, the first access point to the first browsing area of the retail store; displaying, to the first customer via a first touchscreen display disposed in the first browsing area, information regarding a plurality of products stored in a warehouse area of the retail store; while displaying to the first customer via the first touchscreen display information regarding a plurality of products, reading, by a second card reader disposed adjacent a second access point into a second browsing area of the retail store, a second card provided by a second customer; opening, based on the reading of the second card, the second access point to the second browsing area of the retail store; displaying, to the second customer via a second touchscreen display disposed in the second browsing area, information regarding a plurality of products stored in the warehouse area of the retail store; receiving, from the second customer via the second touchscreen display, input corresponding to selection of a first selected product; reading, by a third card reader disposed in the second browsing area, a third card provided by the second customer, and effecting payment for the first selected product utilizing the read third card; receiving, from the first customer via the first touchscreen display, input corresponding to selection of a second selected product; reading, by a fourth card reader disposed in the first browsing area, a fourth card provided by the first customer, and effecting payment for the second selected product utilizing the read fourth card; automatically effecting movement of, via robotic apparatus disposed at the retail store, the first selected product from the warehouse area of the retail store to a dispensing area of the second browsing area of the retail store; and automatically effecting movement of, via robotic apparatus disposed at the retail store, the second selected product from the warehouse area of the retail store to a dispensing area of the first browsing area of the retail store. The plurality of the cards may be different cards, the same card, or a combination of both same and different cards.

Yet further embodiments of the present disclosure may relates to a method for providing a retail automation platform displaying, to a customer via a touchscreen display disposed in a retail store, information regarding a plurality of products stored in a warehouse area of the retail store; receiving, from the customer via the touchscreen display, input corresponding to selection of a selected product of the plurality of products; printing, by a printer disposed adjacent the touchscreen display, a slip comprising an identifier of a cart; reading, by a first card reader disposed at the retail store adjacent an access point to a first retail station, a first card provided by the customer; opening, based on the reading of the first card, the access point to the first retail station of the retail store; receiving, at a device of the first retail station, the identifier of the cart that was printed on the slip; reading, by a second card reader disposed at the first retail station, a second card provided by the customer, and effecting payment for the selected product utilizing the read second card; and automatically effecting movement of, via robotic apparatus disposed at the retail store, the selected product from the warehouse area of the retail store to a dispensing area at the first retail station of the retail store.

In accordance to the various embodiments, receiving, at a device of the first retail station, the identifier of the cart that was printed on the slip comprises receiving input, via a touchscreen display, corresponding to numbers printed on the slip.

In accordance to the various embodiments, receiving, at a device of the first retail station, the identifier of the cart that was printed on the slip comprises receiving input, via a touchscreen display, corresponding to an alphanumeric string printed on the slip.

In accordance to the various embodiments, receiving, at a device of the first retail station, the identifier of the cart that was printed on the slip comprises scanning the slip.

In accordance to the various embodiments, receiving, at a device of the first retail station, the identifier of the cart that was printed on the slip comprises receiving input, via a touchscreen display, corresponding to a cart number.

In accordance to the various embodiments, receiving, at a device of the first retail station, the identifier of the cart that was printed on the slip comprises receiving data corresponding to cart details.

In accordance to the various embodiments, receiving, at a device of the first retail station, the identifier of the cart that was printed on the slip comprises taking a photo of the slip.

Still consistent with embodiments of the present disclosure, a method for automated retail may be provided. The method may comprise displaying, to a customer via a touchscreen display disposed in a retail store, information regarding a plurality of products stored in a warehouse area of the retail store; receiving, from the customer via the touchscreen display, input corresponding to selection of a selected product of the plurality of products; printing, by a printer disposed adjacent the touchscreen display, a slip comprising an identifier of a cart; scanning, by a reader disposed at the retail store adjacent an access point to a first retail station, the slip; opening, based on the reading of the slip, the access point to the first retail station of the retail store; receiving, at a device of the first retail station, the identifier of the cart that was printed on the slip; reading, by a card reader disposed at the first retail station, a card provided by the customer, and effecting payment for the selected product utilizing the read card; and automatically effecting movement of, via robotic apparatus disposed at the retail store, the selected product from the warehouse area of the retail store to a dispensing area at the first retail station of the retail store.

Embodiments of the present disclosure may relate to a method for providing a retail automation platform displaying, to a first customer via a first touchscreen display disposed in a retail store, information regarding a plurality of products stored in a warehouse area of the retail store; receiving, from the first customer via the first touchscreen display, input corresponding to selection of a first selected product; printing, by a printer disposed adjacent the first touchscreen display, a slip comprising an identifier of a cart including the first selected product; reading, by a first reader disposed at the retail store adjacent an access point to a first retail station, a first card or the first slip provided by the first customer; opening, based on the reading of the first card or the first slip, the access point to the first retail station of the retail store; receiving, at a device of the first retail station, the identifier of the cart that was printed on the slip; reading, by a second reader disposed at the first retail station, a second card provided by the first customer, and effecting payment for the selected product utilizing the read second card; automatically effecting movement of, via robotic apparatus disposed at the retail store, the first selected product from the warehouse area of the retail store to a dispensing area at the first retail station of the retail store; reading, by a third reader disposed at a retail store, a third card provided by a second customer; opening, based on the reading of the third card, a second access point to a second retail station of the retail store; displaying, to the second customer via a second touchscreen display disposed at the second retail station, information regarding a plurality of products stored in a warehouse area of the retail store; receiving, from the second customer via the second touchscreen display, input corresponding to selection of a second selected product; reading, by a fourth reader disposed at the second retail station, a fourth card provided by the second customer, and effecting payment for the selected product utilizing the read fourth card; and automatically effecting movement of, via robotic apparatus disposed at the retail store, the selected product from the warehouse area of the retail store to a dispensing area at the second retail station of the retail store.

Furthermore, embodiments of the present disclosure may relate to a method for providing a retail automation platform displaying, to a first customer via a display of an electronic device of the customer, a webpage comprising information regarding a plurality of products stored in a warehouse area of a retail store; receiving, from the first customer via the electronic device, input corresponding to selection of a first selected product; providing, to the first customer, an identifier of a cart including the first selected product; reading, by a first reader disposed at the retail store adjacent an access point to a first retail station, a first card or the first slip provided by the first customer; opening, based on the reading of the first card or a document including the identifier of the cart, the access point to the first retail station of the retail store; receiving, at a device of the first retail station, the identifier of the cart; reading, by a second reader disposed at the first retail station, a second card provided by the first customer, and effecting payment for the selected product utilizing the read second card; automatically effecting movement of, via robotic apparatus disposed at the retail store, the first selected product from the warehouse area of the retail store to a dispensing area at the first retail station of the retail store; reading, by a third reader disposed at a retail store, a third card provided by a second customer; opening, based on the reading of the third card, a second access point to a second retail station of the retail store; displaying, to the second customer via a second touchscreen display disposed at the second retail station, information regarding a plurality of products stored in a warehouse area of the retail store; receiving, from the second customer via the second touchscreen display, input corresponding to selection of a second selected product; reading, by a fourth reader disposed at the second retail station, a fourth card provided by the second customer, and effecting payment for the selected product utilizing the read fourth card; and automatically effecting movement of, via robotic apparatus disposed at the retail store, the selected product from the warehouse area of the retail store to a dispensing area at the second retail station of the retail store.

Yet further embodiments of the present disclosure may relate to a method for providing a retail automation platform displaying, to a customer via a touchscreen display disposed in a retail store, information regarding a plurality of products stored in a warehouse area of the retail store; receiving, from the customer via the touchscreen display, input corresponding to selection of a selected product of the plurality of products; printing, by a printer disposed adjacent the touchscreen display, a slip comprising an identifier of a first selected product; reading, by a first card reader disposed at the retail store adjacent an access point to a first retail station, a first card provided by the customer; opening, based on the reading of the first card, the access point to the first retail station of the retail store; receiving, at a device of the first retail station, the identifier of the first selected product that was printed on the slip; reading, by a second card reader disposed at the first retail station, a second card provided by the customer, and effecting payment for the selected product utilizing the read second card; and automatically effecting movement of, via robotic apparatus disposed at the retail store, the selected product from the warehouse area of the retail store to a dispensing area at the first retail station of the retail store.

Further still, embodiments of the present disclosure may relate to a method for providing a retail automation platform reading, by a first card reader disposed adjacent a first access point into a first browsing area of a retail store, a first card provided by a first customer; opening, based on the reading of the first card, the first access point to the first browsing area of the retail store; displaying, to the first customer via a first touchscreen display disposed in the first browsing area, first information regarding a product stored in a warehouse area of the retail store, the first information including a first price; receiving, from the first customer via the first touchscreen display, input corresponding to selection of the product; reading, by a second card reader disposed in the first browsing area, a second card provided by the first customer, and effecting payment for the product utilizing the read second card; automatically effecting movement of, via robotic apparatus disposed at the retail store, one of the product from the warehouse area of the retail store to a dispensing area of the first browsing area of the retail store; updating, from a location remote from the retail store via an electronic interface associated with the retail store, a price associated with the product; reading, by a third card reader disposed adjacent a second access point into a second browsing area of the retail store, a third card provided by a second customer; opening, based on the reading of the third card, the second access point to the second browsing area of the retail store; displaying, to the second customer via a second touchscreen display disposed in the second browsing area, second information regarding the product, the second information including a second price representing the updated price that is different than the first price; receiving, from the second customer via the second touchscreen display, input corresponding to selection of the product; reading, by a fourth card reader disposed in the second browsing area, a fourth card provided by the second customer, and effecting payment for the product utilizing the read fourth card; and automatically effecting movement of, via robotic apparatus disposed at the retail store, one of the product from the warehouse area of the retail store to a dispensing area of the second browsing area of the retail store.

Various embodiments disclosed herein may relate to a method for providing a retail automation platform reading, by a first card reader disposed adjacent a first access point into a first browsing area of a retail store, a first card provided by a first customer; opening, based on the reading of the first card, the first access point to the first browsing area of the retail store; displaying, to the first customer via a first touchscreen display disposed in the first browsing area, first information regarding a product stored in a warehouse area of the retail store; receiving, from the first customer via the first touchscreen display, input corresponding to selection of the product; reading, by a second card reader disposed in the first browsing area, a second card provided by the first customer, and effecting payment for the product utilizing the read second card; automatically effecting movement of, via robotic apparatus disposed at the retail store, one of the product from the warehouse area of the retail store to a dispensing area of the first browsing area of the retail store; updating, from a location remote from the retail store via an electronic interface associated with the retail store, information associated with the product; reading, by a third card reader disposed adjacent a second access point into a second browsing area of the retail store, a third card provided by a second customer; opening, based on the reading of the third card, the second access point to the second browsing area of the retail store; displaying, to the second customer via a second touchscreen display disposed in the second browsing area, second information regarding the product, the second information including the one or more updates to information associated with the product; receiving, from the second customer via the second touchscreen display, input corresponding to selection of the product; reading, by a fourth card reader disposed in the second browsing area, a fourth card provided by the second customer, and effecting payment for the product utilizing the read fourth card; and automatically effecting movement of, via robotic apparatus disposed at the retail store, one of the product from the warehouse area of the retail store to a dispensing area of the second browsing area of the retail store.

Embodiments of the present disclosure may further relate to a method for providing a retail automation platform displaying, to a customer via a touchscreen display disposed at a lounge of a retail station, information regarding a plurality of products stored in a storage area; receiving, from the customer via the touchscreen display, input corresponding to selection of a selected product of the plurality of products; reading, by a second card reader disposed at the retail station, a second card provided by the customer, and effecting payment for the selected product utilizing the read second card; automatically effecting movement of, via robotic apparatus, the selected product from the storage area to a dispensing area of the retail station.

Embodiments of the present disclosure may relate to a retail station comprising a storage area storing a plurality of products; a lounge area comprising comfortable seating; an access point configured to selectively provide access to the lounge area; a first reader disposed adjacent the access point configured to allow access to the lounge area via the access point; a touchscreen display disposed within the lounge area configured to present information regarding the plurality of products to a user in the lounge area and allow the user to select one of the products for purchase; a second reader disposed adjacent the touchscreen display configured to allow the user to pay for the selected product; and robotic components configured to, based on payment for the selected product, move the selected product from the storage area to a dispensing box in the lounge area. The robotic components may comprise, but not be limited to, a robotic arm, movable tray, and an elevator.

Furthermore, embodiments of the present disclosure may relate to a system comprising a storage area storing a plurality of products; a browsing area; an access point configured to selectively provide access to the browsing area; a first reader disposed adjacent the access point configured to allow access to the lounge area via the access point; a touchscreen display disposed within the lounge area configured to present information regarding the plurality of products to a user in the lounge area and allow the user to select one of the products for purchase; a second reader disposed adjacent the touchscreen display configured to allow the user to pay for the selected product; and robotic components configured to, based on payment for the selected product, move the selected product from the storage area to a dispensing box in the lounge area.

Embodiments of the present disclosure may further relate to a retail station comprising a storage area storing a plurality of products; a lounge area comprising comfortable seating; an access point configured to selectively provide access to the lounge area; a first reader disposed adjacent the access point configured to allow access to the lounge area via the access point; a touchscreen display disposed within the lounge area configured to present information regarding the plurality of products to a user in the lounge area and allow the user to select one of the products for purchase; a second reader disposed adjacent the touchscreen display configured to allow the user to pay for the selected product; and robotic components configured to, based on payment for the selected product, move the selected product from the storage area to a dispensing area in the lounge area; one or more computer readable medium containing computer executable instructions for performing a method comprising reading, by the first reader, a first card provided by a customer; opening, based on the reading of the first card, the access point of the retail station; displaying, to the customer via the touchscreen display, information regarding products stored in the storage area; receiving, from the customer via the touchscreen display, input corresponding to selection of a selected product of the plurality of products; reading, by the second reader, a second card provided by the customer, and effecting payment for the selected product utilizing the read second card; automatically effecting movement of, via the robotic components, the selected product from the storage area to the dispensing area.

Embodiments of the present disclosure may relate to one or more non-transitory computer readable mediums containing computer executable instructions configured to perform a method comprising reading, by a first card reader disposed proximate an access point to a retail station, a first card provided by a customer; opening, based on the reading of the first card, the access point to the retail station; displaying, to the customer via a touchscreen display disposed at the retail station, information regarding a plurality of products stored in a storage area; receiving, from the customer via the touchscreen display, input corresponding to selection of a selected product of the plurality of products; reading, by a second card reader disposed at the retail station, a second card provided by the customer, and effecting payment for the selected product utilizing the read second card; automatically effecting movement of, via robotic apparatus, the selected product from the storage area to a dispensing area of the retail station.

Further still, embodiments of the present disclosure may relate to a method for providing a retail automation platform displaying, to a customer via a touchscreen display disposed in a retail store, information regarding a plurality of products stored in a warehouse area of the retail store; receiving, from the customer via the touchscreen display, input corresponding to selection of a selected product of the plurality of products; printing, by a printer disposed adjacent the touchscreen display, a slip comprising a barcode; reading, by a first reader disposed at the retail store adjacent an access point to a first retail station, a first card provided by the customer or the barcode printed on the slip; opening, based on the reading of the first card or the barcode, the access point to the first retail station of the retail store; reading, at the first retail station, the barcode that was printed on the slip; reading, at the first retail station, a second card provided by the customer, and effecting payment for the selected product utilizing the read second card; and automatically effecting movement of, via robotic apparatus disposed at the retail store, the selected product from the warehouse area of the retail store to a dispensing area at the first retail station of the retail store.

Various embodiments of the present disclosure may relate to one or more non-transitory computer readable mediums containing computer executable instructions configured to perform a method comprising reading, by a first card reader disposed proximate an access point to a retail station, a first card provided by a customer; opening, based on the reading of the first card, the access point to the retail station; displaying, to the customer via a touchscreen display disposed at the retail station, information regarding a plurality of products stored in a storage area; receiving, from the customer via the touchscreen display, input corresponding to selection of a selected product of the plurality of products; reading, by a second card reader disposed at the retail station, a second card provided by the customer, and effecting payment for the selected product utilizing the read second card; automatically effecting movement of, via robotic apparatus, the selected product from the storage area to a dispensing area of the retail station.

Further embodiments of the present disclosure may relate to a method for providing a retail automation platform displaying, to a customer via a touchscreen display disposed in a retail store, information regarding a plurality of products stored in a warehouse area of the retail store; receiving, from the customer via the touchscreen display, input corresponding to selection of a selected product of the plurality of products; printing, by a printer disposed adjacent the touchscreen display, a slip comprising an identifier of a cart; reading, by a first card reader disposed at the retail store adjacent an access point to a first retail station, a first card provided by the customer; opening, based on the reading of the first card, the access point to the first retail station of the retail store; receiving, via a microphone disposed at the first retail station, voice input corresponding to the identifier of the cart that was printed on the slip; reading, by a second card reader disposed at the first retail station, a second card provided by the customer, and effecting payment for the selected product utilizing the read second card; and automatically effecting movement of, via robotic apparatus disposed at the retail store, the selected product from the warehouse area of the retail store to a dispensing area at the first retail station of the retail store.

Embodiments disclosed herein relate to one or more non-transitory computer readable mediums containing computer executable instructions configured to perform a disclosed method. Others aspects relate to disclosed methods, systems, and apparatus.

One or more perceived needs are believed to be met by one or more aspects and features of the embodiments disclosed herein. Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The present disclosers includes many aspects and features. Moreover, while many aspects and features relate to, and are described in, the context of the retail industry, embodiments of the present disclosure are not limited to use only in this context, as will become apparent from the following summaries and detailed descriptions of aspects, features, and one or more embodiments disclosed herein.

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates an embodiment of retail automation platform 100, wherein two customer shopping lounges are provided.

FIG. 2 illustrates an embodiment of retail automation platform 200, wherein a plurality of customer shopping lounges are provided; and

FIG. 3 illustrates a perspective view 300 of an embodiment of retail automation platform 100.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. As should be understood, any embodiment may incorporate only one or a plurality of the above-disclosed aspects of the display and may further incorporate only one or a plurality of the above-disclosed features. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosers includes many aspects and features. Moreover, while many aspects and features relate to, and are described in, the context of retail shopping, embodiments of the present disclosure are not limited to use only in this context.

### I. Platform Overview

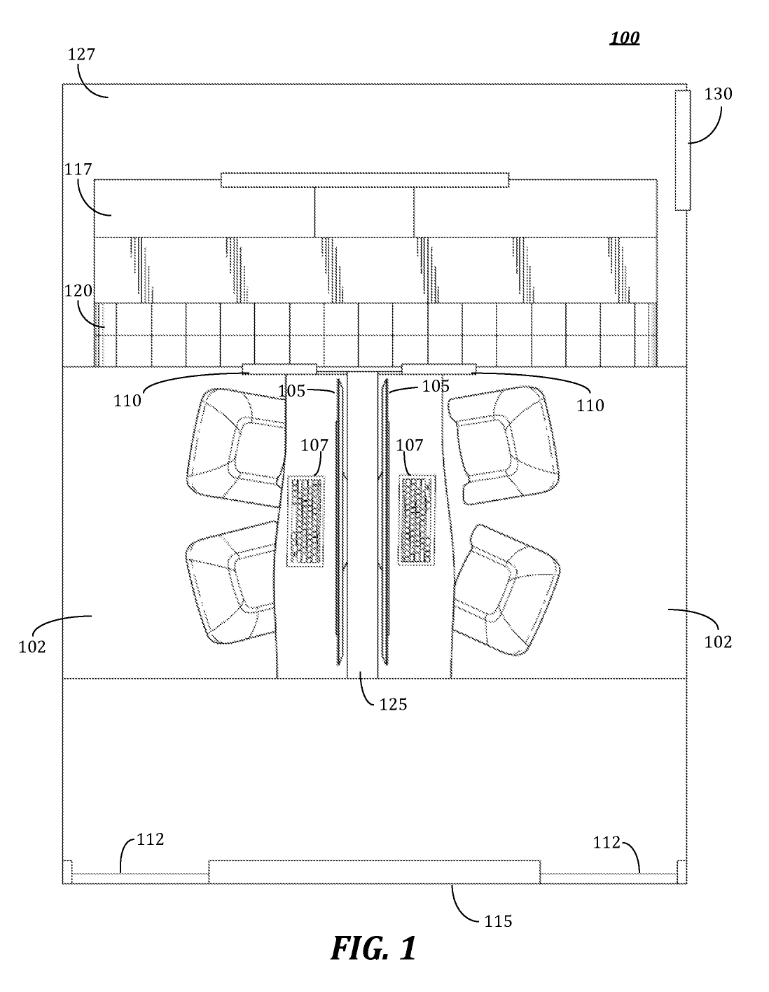

Turning now to FIG. 1, a retail shopping platform 100 in accordance with one or more aspects and features of the various embodiments is shown in plan view. Platform 100 may consists of, but not be limited to, for example, two customer shopping rooms or lounges 102. Each lounge may include one or more chairs and a large display, such as an LCD or plasma screen 105, for viewing audiovisual presentations of products for sale. A support surface, such as a surface of a desktop, table, or shelf, may be provided on which is supported a user input device 107 such as a wireless keyboard, a touchpad, a tablet having a touchscreen, or other electronic device that enables customer navigation and selection of products for viewing presentations relating thereto on the large display. The user input device in the lounge may further enable input by the user. The input may comprise, for example, u customer identification, user input comprising shopping cart identification, and user input comprising payment information.

Entrance to each lounge may be by a door 112, illustrated as sliding door in the drawings. The door may be lockable and unlockable automatically. In some embodiments, a customer may gain access to the lounge through an exterior user input device 115 such as a wall-mounted touchscreen electronic device. The device further may include or be accompanied by a card reader for swiping of a credit card, customer identification, or other card carried by the customer. In various embodiments, a customer cannot gain access if the lounge is occupied; however, a person in an occupied room can open or otherwise activate the door to provide admittance to a person exterior to the room.

A delivery access door may be further provided in the room whereat merchandise that is purchased may be delivered to a customer in an occupied room. The delivery access door is indicated generally at 110 in FIG. 1. The merchandise that is purchased may be automatically delivered to the delivery access door for presentation to the customer by, for example, but not limited to, computer controlled mechanisms, including for example one or more robotic controls, arms, or devices. As shown, the delivery access door is located proximate the support surface; however, the delivery access door may be located anywhere along the wall of the room separating the room from the automated product transit area.

Merchandise is pulled by the computer controlled mechanisms from a storage area 117 located adjacent an automated product transit area 120 through which pulled merchandise is transported. The storage area may comprise shelves or cubbyholes in which merchandise is stored while awaiting sale. The automated product transit area may comprise a pathway for one or more movable, wirelessly controlled robotic pallets, or may comprise a computer controlled conveyor system 125.

An extra storage and service area 127 may be provided on a side of the storage area opposite to the side on which the lounges are located. The extra storage and service area is accessed by a worker through the illustrated service door 130 for restocking of the storage area and maintenance of the system.

In providing an automated retail shopping experience for a customer in platform 100, a customer may swipe his or her credit card at the exterior user input device corresponding to an unoccupied lounger, upon which the door unlocks and opens to admit the customer. In some embodiments, the customer may be enabled to take a seat and initiate shopping using the interior user input device and large display. The shopping may be accomplished by browsing and viewing presentations for merchandise that is available for sale at that time in platform 100. Such browsing may resemble browsing and viewing of products that is conventionally done online over the Internet. Upon completion of shopping and consummation of the retail transaction, including processing and authorization of the credit card for the desired purchase, the merchandise is delivered to the customer for immediate satisfaction.

Embodiments may provide an express shopping experience in that a customer is enabled to browse and view presentations for merchandise that is available for sale at that time in platform 100 using any of the exterior user input devices that include a display, such as, for example, a touchscreen. While not enjoying the private, comfortable experience of being seated in a secluded room to the exclusion of the public, the functionality provided by the exterior user input device may, in various embodiments, be the same as that of the interior user input device for such browsing and consummation of a retail sale, if desired. It furthermore is noted that the audiovisual capabilities at the exterior user input device may be limited as compared to the audiovisual capabilities in a lounge. For example, a lounge may be fitted with surround sound and other high quality equipment for movie-like effect.

Upon completion of shopping and consummation of the retail transaction, including processing and authorization of the credit card for the desired purchase, the merchandise is delivered to the customer for immediate satisfaction at the express delivery area adjacent to the exterior user input device used. Each express delivery area may, in various embodiments, be an orthogonal extension of the automated product transit area, as illustrated in the drawings.

Additionally, it is contemplated that a customer can begin a shopping experience at an exterior user input device, save a shopping cart, and then proceed to an unoccupied lounge, retrieve the saved shopping cart, and continue the shopping experience, wherein the product may be delivered to the user at the unoccupied lounge.

Further still, it is contemplated that a customer can begin a shopping experience online over the Internet using, for example, an electronic device of the customer, such as a web-enabled smartphone, and similarly complete the shopping experience at an external user input device or in a lounge by retrieving a saved shopping cart. Alternatively, it is further contemplated that a customer can consummate the transaction on the customer device and pick-up the purchased merchandise at an express delivery area or in a lounge by identifying the customer order using the corresponding user input device.

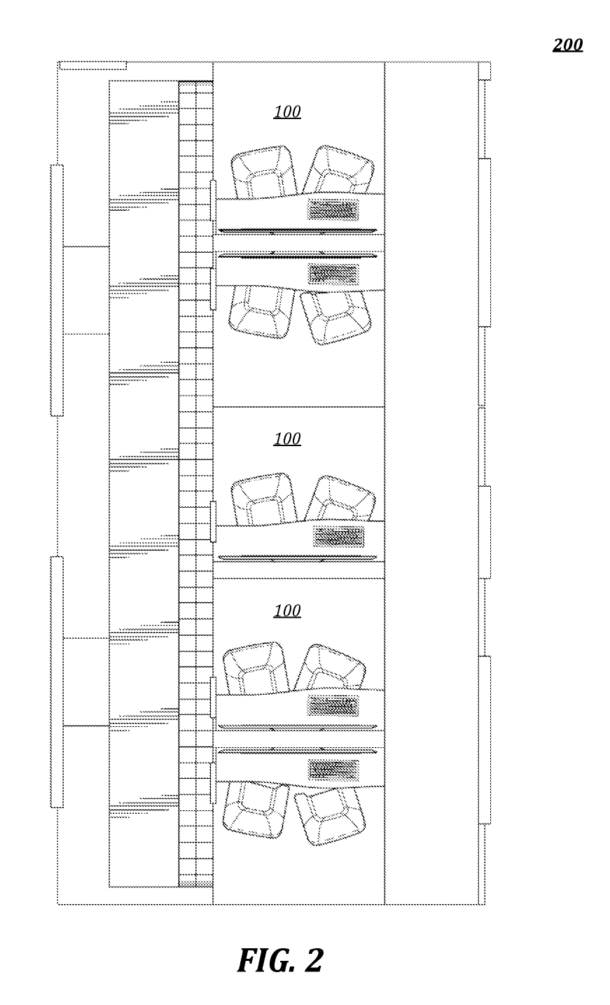

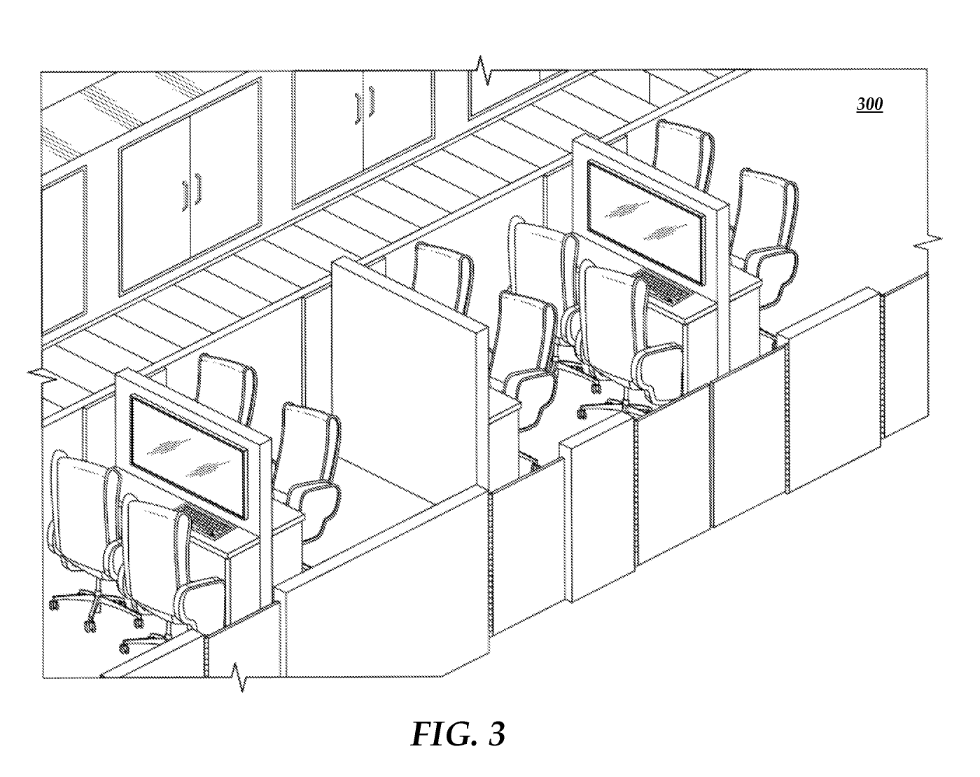

Further embodiments of retail automation platform 100 are illustrated as platform 200 shown in plan view in FIG. 2, wherein a plurality of shopping rooms or lounges are provided. FIG. 3 illustrates a perspective view 300 of the embodiments shown in FIGS. 1-2. It should be understood that the dimensions are not drawn to scale.

Consistent with embodiments disclosed here, one or more retail automation platform may be located at public areas, such as airports, shopping malls, or hotels.

Moreover, it is contemplated that a retail automation platform may be located within its own retail space and comprise its own store. In any scenario, such system may be unmanned in that a sales person or sales associate may not be required for facilitating sale of merchandise to a customer.

Additionally, a central control may be provided for operation of a plurality of platforms remotely located from the platforms. The central control may monitors inventory, sales, and online activity of the systems, providing logistics and security for each of the systems. Security further may include video surveillance as well as audio and/or video communications with a customer service representative located at the central control or otherwise remotely located for facilitating and educating customers in the automated shopping experiences provided by the systems.

Accordingly, and consistent with embodiments of the present disclosure, the platform may be managed remotely. Prices, publicity screens, system maintenance, surveillance, and the like, may be managed from a central control office. Email warnings may be automatically sent to appropriate persons to notify of inventory reload points, system failures, etc.

In various embodiments, the merchandise made available for retail sale in a platform consistent with embodiments of the present disclosure may, in some embodiments, not comprise its own retail store when it's dimensions fall in the approximate range of, for example, 8″×3″×2″ (8 oz) to 16″×9″×16″ (3 lb), especially where the space made available to accommodate the system is relatively small.

### II. Platform Configuration

By way of illustration, and not limitation, in an illustrative example of a platform 100, a customer may be enabled to enter a store where there is no sales assistant, just interactive displays (e.g., touchscreens) in a comfortable environment. Here the customer may sit down and reviews all the retailer's products (the retailer may be the platform provider), experiencing the various or singular brands through videos, music and pictures.

The platform may comprise many lounges such that different customers can sit down and operate at the same time. Embodiments may provide one warehouse at, for example, the back of the premises that is closed to the public by a solid wall and, ideally, the customer may not so readily realize that there is a warehouse located near the lounge.

The warehouse may stock all the products that are made available for sale at a given time, by using a logistic system, with robotic technology. The robotic technology may be operative to organize the stock, pick up the product and deliver it directly to the customer, seated on the other side of the wall within a few seconds. The products in the warehouse may already carefully wrapped in its original packaging and gift presentation, and can be delivered within seconds, once the customer has paid.

During the customer's platform experience, short videos with a length between, for example, but not limited to, 5 and 90 seconds may be played, in which the product is displayed on the interactive screen. The customer can also review pictures of the product, description of the product, or move the product on the screen, to see it form different perspectives.

In some embodiments, exterior touchscreen monitors may be provided at an entrance where a potential customer can preview the products and also select them for purchase. The customer can then print the selection with a number assigned to it. Once inside the store the customer will be given the choice to introduce the number and recover the selection. The selection may be in the form of a “shopping cart”.

In some embodiments, merchandise will be pulled upon a transaction being consummated, with consummated transactions being fulfilled in sequential order. Just when the picking system has finished the first order, the platform may start working on the second order made by the next customer. The platform may be configured to instantly update the inventory when a customer takes the product to the cart.

Example specifications of an illustrative system are set forth below:
Area 117 may comprised fixed shelving with variable “with” depending on the size of products it accommodates. A robotic arm may be configured to transport the product from its position.
Area 127 may comprise a robotic arm that moves though carriages looking for a selected product. The arm may transport the product (the method of picking may depend on the packaging and storage of the products) and then deposits it in a dispensing box corresponding to the station in which the customer is located. This may further require machine level software and integration with customer interface below.
Customer Interface (elements 105, 106, 115) may comprise software operating in conjunction with a processing unit, memory storage, output device (e.g., display monitors) and input device (e.g., touch interface). The software may be configured to provide a user friendly experience.
Hardware:
   a. Embodiments outside lounge 102:
      i. 1 32″ or bigger single point touchscreen per station.
      ii. 1 thermal printer, to print the cart detail and number, per station.
      iii. 1 Credit card reader to activate the sliding door per station.
   b. Embodiments inside lounge 102:
      i. 1 32″ or bigger single point touchscreen per station.
      ii. 1 credit card reader per station.
      iii. 1 thermal printer, to print the receipt per station.
      iv. 1 surveillance camera per station.
      v. 1 dispensing box per station.
      vi. 2 surveillance cameras.
      vii. 1 CPU per station+server.
      viii. PCB for robot or elevator.
      ix. Movable trays or fixed shelf.

It will be appreciated from the foregoing illustrative example that:
The platform may be operative with two or more customers at the same time and, in various embodiments, the platform may deliver the orders in the order in which they are received.
The platform may be operative to receive preorders from:
   The outside devices where the customers could browse, select and add to the cart the desired products. The platform may print a cart pre-checkup. Then the customer enters the lounge room and may type or dictate the cart number or scan the printed barcode. The cart appears for the customer to be able to make changes or proceed for final checkout.
   The customer could browse, select and prepare their pre-cart through a platform webpage, web-apps or any other system that could access the system out of the premises.
The platform may offer an express delivery with select products from the outside device.
The platform may offer a unique experience of purchase. The customer could sit while surfing the system.
The platform may be scalable. Each basic module may have two cubicles for two or more customers and one or two outside devices for preorders or express delivery. Depending of the available space, the platform may be able to combine as many basic modules as wanted.

### III. Platform Operation

The follow disclosure sets for the general stages and devices involved in providing a retail automation platform. Although methods are described to be performed by the platform, it should be understood that the platform may be comprised of a plurality yo elements, including network elements and computing devices may be used to perform the various stages. Furthermore, in some embodiments, different operations may be performed by different networked elements in operative communication with the platform. For example, a server may be employed in the performance of some or all of the stages.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein.

Although the following is written in a style similar to claim language, it is not to be construed as claims but, rather, as features to various embodiments of the present disclosure.

1. A method for providing a retail automation platform comprising:
(a) reading, by a first card reader disposed proximate an access point to a retail station, a first card provided by a customer;
(b) opening, based on the reading of the first card, the access point to the retail station;
(c) displaying, to the customer via a touchscreen display disposed at the retail station, information regarding a plurality of products stored in a storage area;
(d) receiving, from the customer via the touchscreen display, input corresponding to selection of a selected product of the plurality of products;
(e) reading, by a second card reader disposed at the retail station, a second card provided by the customer, and effecting payment for the selected product utilizing the read second card;
(f) automatically effecting movement of, via robotic apparatus, the selected product from the storage area to a dispensing area of the retail station.

2. The method of element 1, wherein the retail station is located at an airport.
3. The method of element 1, wherein the retail station is located at a retail store.
4. The method of element 1, wherein the retail station is located at a shopping mall.
5. The method of element 1, wherein the retail station is located at a hotel.
6. The method of element 1, wherein the first card and the second card are the same card.
7. The method of element 1, wherein the first card and the second card are different cards.
8. The method of element 1, wherein the first card comprises a credit card.
9. The method of element 1, wherein the first card comprises a loyalty or reward card.
10. The method of element 1, wherein the first card comprises a gift card.
11. The method of element 1, wherein the first card comprises an identification card.
12. The method of element 1, wherein the first card comprises a debit card.
13. The method of element 1, wherein the second card comprises a credit card.
14. The method of element 1, wherein the second card comprises a debit card.
15. The method of element 1, wherein the first card reader is disposed adjacent the access point.
16. The method of element 1, wherein the access point comprises a sliding door.
17. The method of element 1, wherein the access point comprises a sliding glass door.

18. The method of element 1, wherein the access point comprises glass.

19. The method of element 1, wherein opening, based on the reading of the first card, the access point comprises authenticating the first card.

20. The method of element 1, wherein displaying, to the customer via a touchscreen display, information regarding a plurality of products stored in a storage area comprises displaying a video.

21. The method of element 1, wherein displaying, to the customer via a touchscreen display, information regarding a plurality of products stored in a storage area comprises displaying one or more photographs.

22. The method of element 1, wherein displaying, to the customer via a touchscreen display, information regarding a plurality of products stored in a storage area comprises displaying a 3d model of a product that the customer can rotate using the touchscreen display.

23. The method of element 1, wherein displaying, to the customer via a touchscreen display, information regarding a plurality of products stored in a storage area comprises displaying a written description of a product.

24. The method of element 1, wherein displaying, to the customer via a touchscreen display, information regarding a plurality of products stored in a storage area comprises displaying a video that is around five seconds long.

25. The method of element 1, wherein displaying, to the customer via a touchscreen display, information regarding a plurality of products stored in a storage area comprises displaying a video that is at least five seconds long.

26. The method of element 1, wherein displaying, to the customer via a touchscreen display, information regarding a plurality of products stored in a storage area comprises displaying a video that is around ninety seconds long.

27. The method of element 1, wherein displaying, to the customer via a touchscreen display, information regarding a plurality of products stored in a storage area comprises displaying a video that is no longer than ninety seconds long.

28. The method of element 1, wherein displaying, to the customer via a touchscreen display, information regarding a plurality of products stored in a storage area comprises displaying a video that is somewhere between four seconds long and ninety one seconds long.

29. The method of element 1, wherein displaying, to the customer via a touchscreen display, information regarding a plurality of products stored in a storage area comprises displaying multiple images of a product.

30. The method of element 1, wherein the method further includes capturing, via a surveillance camera, video of the retail station.

31. The method of element 1, wherein the retail station comprises one or more pieces of comfortable furniture.

32. The method of element 1, wherein the retail station comprises a lounge.

33. The method of element 1, wherein the retail station comprises a couch.

34. The method of element 1, wherein the retail station comprises one or more comfortable chairs.

35. The method of element 1, wherein the retail station comprises one or more speakers.

36. The method of element 1, wherein the retail station comprises surround sound speakers.

37. The method of element 1, wherein the method further comprises printing a receipt for the purchase of the selected product.

38. The method of element 1, wherein the method further comprises printing, using a thermal printer, a receipt for the purchase of the selected product.

39. The method of element 1, wherein the retail station comprises a plurality of chairs.

40. The method of element 1, wherein the retail station comprises a plurality of chairs and room to dispose rolling luggage.

41. A method for providing a retail automation platform comprising:
(a) reading, by a first card reader disposed at a retail store, a first card provided by a customer;
(b) opening, based on the reading of the first card, an access point to a browsing area of the retail store;
(c) displaying, to the customer via a touchscreen display disposed in the browsing area, information regarding a plurality of products stored in a warehouse area of the retail store;
(d) receiving, from the customer via the touchscreen display, input corresponding to selection of a selected product of the plurality of products;
(e) reading, by a second card reader disposed in the browsing area, a second card provided by the customer, and effecting payment for the selected product utilizing the read second card;
(f) automatically effecting movement of, via robotic apparatus disposed at the retail store, the selected product from the warehouse area of the retail store to a dispensing area of the browsing area of the retail store.

42. The method of element 41, wherein the first card and the second card are the same card.

43. The method of element 41, wherein the first card and the second card are different cards.

44. The method of element 41, wherein the first card comprises a credit card.

45. The method of element 41, wherein the first card comprises a loyalty or reward card.

46. The method of element 41, wherein the first card comprises a gift card.

47. The method of element 41, wherein the first card comprises an identification card.

48. The method of element 41, wherein the first card comprises a debit card.

49. The method of element 41, wherein the second card comprises a credit card.

50. The method of element 41, wherein the second card comprises a debit card.

51. The method of element 41, wherein the first card reader is disposed adjacent the access point.

52. The method of element 41, wherein the access point comprises a sliding door.

53. The method of element 41, wherein the access point comprises a sliding glass door.

54. The method of element 41, wherein the access point comprises glass.

55. The method of element 41, wherein opening, based on the reading of the first card, an access point to a browsing area of the retail store comprises authenticating the first card.

56. The method of element 41, wherein displaying, to the customer via a touchscreen display disposed in the browsing area, information regarding a plurality of products stored in a warehouse area of the retail store comprises displaying a video.

57. The method of element 41, wherein displaying, to the customer via a touchscreen display disposed in the browsing area, information regarding a plurality of products stored in a warehouse area of the retail store comprises displaying one or more photographs.

58. The method of element 41, wherein displaying, to the customer via a touchscreen display disposed in the browsing area, information regarding a plurality of products stored in a warehouse area of the retail store comprises displaying a 3d model of a product that the customer can rotate using the touchscreen display.

59. The method of element 41, wherein displaying, to the customer via a touchscreen display disposed in the browsing area, information regarding a plurality of products stored in a warehouse area of the retail store comprises displaying a written description of a product.

60. The method of element 41, wherein displaying, to the customer via a touchscreen display disposed in the browsing area, information regarding a plurality of products stored in a warehouse area of the retail store comprises displaying a video that is around five seconds long.

61. The method of element 41, wherein displaying, to the customer via a touchscreen display disposed in the browsing area, information regarding a plurality of products stored in a warehouse area of the retail store comprises displaying a video that is at least five seconds long.

62. The method of element 41, wherein displaying, to the customer via a touchscreen display disposed in the browsing area, information regarding a plurality of products stored in a warehouse area of the retail store comprises displaying a video that is around ninety seconds long.

63. The method of element 41, wherein displaying, to the customer via a touchscreen display disposed in the browsing area, information regarding a plurality of products stored in a warehouse area of the retail store comprises displaying a video that is no longer than ninety seconds long.

64. The method of element 41, wherein displaying, to the customer via a touchscreen display disposed in the browsing area, information regarding a plurality of products stored in a warehouse area of the retail store comprises displaying a video that is somewhere between four seconds long and ninety one seconds long.

65. The method of element 41, wherein displaying, to the customer via a touchscreen display disposed in the browsing area, information regarding a plurality of products stored in a warehouse area of the retail store comprises displaying multiple images of a product.

66. The method of element 41, wherein automatically effecting movement of, via robotic apparatus disposed at the retail store, the selected product from the warehouse area of the retail store to a dispensing area of the browsing area of the retail store comprises movement of the selected product via a robotic arm.

67. The method of element 41, wherein automatically effecting movement of, via robotic apparatus disposed at the retail store, the selected product from the warehouse area of the retail store to a dispensing area of the browsing area of the retail store comprises movement of a movable tray.

68. The method of element 41, wherein automatically effecting movement of, via robotic apparatus disposed at the retail store, the selected product from the warehouse area of the retail store to a dispensing area of the browsing area of the retail store comprises use of an elevator which receives the product and facilitates its movement to the dispensing area of the browsing area.

69. The method of element 41, wherein the dispensing area of the browsing area comprises a dispensing box.

70. The method of element 41, wherein the method further includes capturing, via a surveillance camera, video of the browsing area.

71. The method of element 41, wherein the browsing area of the retail store comprises one or more pieces of comfortable furniture.

72. The method of element 41, wherein the browsing area comprises a lounge.

73. The method of element 41, wherein the browsing area comprises a couch.

74. The method of element 41, wherein the browsing area comprises one or more comfortable chairs.

75. The method of element 41, wherein the browsing area comprises one or more speakers.

76. The method of element 41, wherein the browsing area comprises surround sound speakers.

77. The method of element 41, wherein the method further comprises printing a receipt for the purchase of the selected product.

78. The method of element 41, wherein the method further comprises printing, using a thermal printer, a receipt for the purchase of the selected product.

79. A method for providing a retail automation platform comprising:
(a) reading, by a first card reader disposed at a retail store, a first card provided by a customer;
(b) opening, based on the reading of the first card, an access point to a browsing area of the retail store;
(c) displaying, to the customer via a touchscreen display disposed in the browsing area, information regarding a plurality of products stored in a warehouse area of the retail store;
(d) receiving, from the customer via the touchscreen display, input corresponding to selection of a selected product of the plurality of products;
(e) reading, by a second card reader disposed in the browsing area, a second card provided by the customer, and effecting payment for the selected product utilizing the read second card;
(f) automatically effecting movement of, via apparatus disposed at the retail store, the selected product from the warehouse area of the retail store to a dispensing area of the browsing area of the retail store.

80. A method for providing a retail automation platform comprising:
(a) displaying, to a customer via a touchscreen display disposed in a browsing area of a retail store, information regarding a plurality of products stored in a warehouse area of the retail store;
(b) receiving, from the customer via the touchscreen display, input corresponding to selection of a selected product of the plurality of products;
(c) reading, by a card reader disposed in the browsing area, a card provided by the customer, and effecting payment for the selected product utilizing the read card; and
(d) automatically effecting movement of, via robotic apparatus disposed at the retail store, the selected product from the warehouse area of the retail store to a dispensing area of the browsing area of the retail store.

81. A method for providing a retail automation platform comprising:
(a) displaying, to a customer via a touchscreen display disposed in a browsing area of a retail store, information regarding a plurality of products stored in a warehouse area of the retail store;
(b) receiving, from the customer via the touchscreen display, input corresponding to selection of a selected product of the plurality of products;
(c) reading, by a card reader disposed in the browsing area, a card provided by the customer, and effecting payment for the selected product utilizing the read card; and
(d) automatically effecting movement of, via apparatus disposed at the retail store, the selected product from the warehouse area of the retail store to a dispensing area of the browsing area of the retail store.

82. A method for providing a retail automation platform comprising:
(a) reading, by a first card reader disposed adjacent a first access point into a first browsing area of a retail store, a first card provided by a first customer;
(b) opening, based on the reading of the first card, the first access point to the first browsing area of the retail store;
(c) displaying, to the first customer via a first touchscreen display disposed in the first browsing area, information regarding a plurality of products stored in a warehouse area of the retail store;
(d) while displaying to the first customer via the first touchscreen display information regarding a plurality of products, reading, by a second card reader disposed adjacent a second access point into a second browsing area of the retail store, a second card provided by a second customer;
(e) opening, based on the reading of the second card, the second access point to the second browsing area of the retail store;
(f) displaying, to the second customer via a second touchscreen display disposed in the second browsing area, information regarding a plurality of products stored in the warehouse area of the retail store;
(g) receiving, from the second customer via the second touchscreen display, input corresponding to selection of a first selected product;
(h) reading, by a third card reader disposed in the second browsing area, a third card provided by the second customer, and effecting payment for the first selected product utilizing the read third card;
(i) receiving, from the first customer via the first touchscreen display, input corresponding to selection of a second selected product;
(j) reading, by a fourth card reader disposed in the first browsing area, a fourth card provided by the first customer, and effecting payment for the second selected product utilizing the read fourth card;
(k) automatically effecting movement of, via robotic apparatus disposed at the retail store, the first selected product from the warehouse area of the retail store to a dispensing area of the second browsing area of the retail store; and
(l) automatically effecting movement of, via robotic apparatus disposed at the retail store, the second selected product from the warehouse area of the retail store to a dispensing area of the first browsing area of the retail store.

83. The method of element 82, wherein the first, second, third, and fourth cards are all different cards.

84. The method of element 82, wherein the first and fourth cards are the same card.

85. The method of element 82, wherein the first and fourth cards are different cards.

86. The method of element 82, wherein the second and third cards are different cards.

87. The method of element 82, wherein the second and third cards are the same card.

88. The method of element 82, wherein the third card is a credit card.

89. The method of element 82, wherein the third card is a debit card.

90. The method of element 82, wherein the fourth card is a credit card.

91. The method of element 82, wherein the fourth card is a debit card.

92. A method for providing a retail automation platform comprising:
(a) displaying, to a customer via a touchscreen display disposed in a retail store, information regarding a plurality of products stored in a warehouse area of the retail store;
(b) receiving, from the customer via the touchscreen display, input corresponding to selection of a selected product of the plurality of products;
(c) printing, by a printer disposed adjacent the touchscreen display, a slip comprising an identifier of a cart;
(d) reading, by a first card reader disposed at the retail store adjacent an access point to a first retail station, a first card provided by the customer;
(e) opening, based on the reading of the first card, the access point to the first retail station of the retail store;
(f) receiving, at a device of the first retail station, the identifier of the cart that was printed on the slip;
(g) reading, by a second card reader disposed at the first retail station, a second card provided by the customer, and effecting payment for the selected product utilizing the read second card; and
(h) automatically effecting movement of, via robotic apparatus disposed at the retail store, the selected product from the warehouse area of the retail store to a dispensing area at the first retail station of the retail store.

93. The method of element 92, wherein receiving, at a device of the first retail station, the identifier of the cart that was printed on the slip comprises receiving input, via a touchscreen display, corresponding to numbers printed on the slip.

94. The method of element 92, wherein receiving, at a device of the first retail station, the identifier of the cart that was printed on the slip comprises receiving input, via a touchscreen display, corresponding to an alphanumeric string printed on the slip.

95. The method of element 92, wherein receiving, at a device of the first retail station, the identifier of the cart that was printed on the slip comprises scanning the slip.

96. The method of element 92, wherein receiving, at a device of the first retail station, the identifier of the cart that was printed on the slip comprises receiving input, via a touchscreen display, corresponding to a cart number.

97. The method of element 92, wherein receiving, at a device of the first retail station, the identifier of the cart that was printed on the slip comprises receiving data corresponding to cart details.

98. The method of element 92, wherein receiving, at a device of the first retail station, the identifier of the cart that was printed on the slip comprises taking a photo of the slip.

99. A method for providing a retail automation platform comprising:
(a) displaying, to a customer via a touchscreen display disposed in a retail store, information regarding a plurality of products stored in a warehouse area of the retail store;
(b) receiving, from the customer via the touchscreen display, input corresponding to selection of a selected product of the plurality of products;
(c) printing, by a printer disposed adjacent the touchscreen display, a slip comprising an identifier of a cart;
(d) scanning, by a reader disposed at the retail store adjacent an access point to a first retail station, the slip;
(e) opening, based on the reading of the slip, the access point to the first retail station of the retail store;
(f) receiving, at a device of the first retail station, the identifier of the cart that was printed on the slip;
(g) reading, by a card reader disposed at the first retail station, a card provided by the customer, and effecting payment for the selected product utilizing the read card; and
(h) automatically effecting movement of, via robotic apparatus disposed at the retail store, the selected product from the warehouse area of the retail store to a dispensing area at the first retail station of the retail store.

100. A method for providing a retail automation platform comprising:
(a) displaying, to a first customer via a first touchscreen display disposed in a retail store, information regarding a plurality of products stored in a warehouse area of the retail store;
(b) receiving, from the first customer via the first touchscreen display, input corresponding to selection of a first selected product;
(c) printing, by a printer disposed adjacent the first touchscreen display, a slip comprising an identifier of a cart including the first selected product;
(d) reading, by a first reader disposed at the retail store adjacent an access point to a first retail station, a first card or the first slip provided by the first customer;
(e) opening, based on the reading of the first card or the first slip, the access point to the first retail station of the retail store;
(f) receiving, at a device of the first retail station, the identifier of the cart that was printed on the slip;
(g) reading, by a second reader disposed at the first retail station, a second card provided by the first customer, and effecting payment for the selected product utilizing the read second card;
(h) automatically effecting movement of, via robotic apparatus disposed at the retail store, the first selected product from the warehouse area of the retail store to a dispensing area at the first retail station of the retail store;
(i) reading, by a third reader disposed at a retail store, a third card provided by a second customer;
(j) opening, based on the reading of the third card, a second access point to a second retail station of the retail store;
(k) displaying, to the second customer via a second touchscreen display disposed at the second retail station, information regarding a plurality of products stored in a warehouse area of the retail store;
(l) receiving, from the second customer via the second touchscreen display, input corresponding to selection of a second selected product;
(m) reading, by a fourth reader disposed at the second retail station, a fourth card provided by the second customer, and effecting payment for the selected product utilizing the read fourth card; and
(n) automatically effecting movement of, via robotic apparatus disposed at the retail store, the selected product from the warehouse area of the retail store to a dispensing area at the second retail station of the retail store.

101. A method for providing a retail automation platform comprising:
(a) displaying, to a first customer via a display of an electronic device of the customer, a webpage comprising information regarding a plurality of products stored in a warehouse area of a retail store;
(b) receiving, from the first customer via the electronic device, input corresponding to selection of a first selected product;
(c) providing, to the first customer, an identifier of a cart including the first selected product;
(d) reading, by a first reader disposed at the retail store adjacent an access point to a first retail station, a first card or the first slip provided by the first customer;
(e) opening, based on the reading of the first card or a document including the identifier of the cart, the access point to the first retail station of the retail store;
(f) receiving, at a device of the first retail station, the identifier of the cart;
(g) reading, by a second reader disposed at the first retail station, a second card provided by the first customer, and effecting payment for the selected product utilizing the read second card;
(h) automatically effecting movement of, via robotic apparatus disposed at the retail store, the first selected product from the warehouse area of the retail store to a dispensing area at the first retail station of the retail store;
(i) reading, by a third reader disposed at a retail store, a third card provided by a second customer;
(j) opening, based on the reading of the third card, a second access point to a second retail station of the retail store;
(k) displaying, to the second customer via a second touchscreen display disposed at the second retail station, information regarding a plurality of products stored in a warehouse area of the retail store;
(l) receiving, from the second customer via the second touchscreen display, input corresponding to selection of a second selected product;
(m) reading, by a fourth reader disposed at the second retail station, a fourth card provided by the second customer, and effecting payment for the selected product utilizing the read fourth card; and
(n) automatically effecting movement of, via robotic apparatus disposed at the retail store, the selected product from the warehouse area of the retail store to a dispensing area at the second retail station of the retail store.

102. A method for providing a retail automation platform comprising:
(a) displaying, to a customer via a touchscreen display disposed in a retail store, information regarding a plurality of products stored in a warehouse area of the retail store;
(b) receiving, from the customer via the touchscreen display, input corresponding to selection of a selected product of the plurality of products;
(c) printing, by a printer disposed adjacent the touchscreen display, a slip comprising an identifier of a first selected product;
(d) reading, by a first card reader disposed at the retail store adjacent an access point to a first retail station, a first card provided by the customer;
(e) opening, based on the reading of the first card, the access point to the first retail station of the retail store;
(f) receiving, at a device of the first retail station, the identifier of the first selected product that was printed on the slip;
(g) reading, by a second card reader disposed at the first retail station, a second card provided by the customer, and effecting payment for the selected product utilizing the read second card; and
(h) automatically effecting movement of, via robotic apparatus disposed at the retail store, the selected product from the warehouse area of the retail store to a dispensing area at the first retail station of the retail store.

103. A method for providing a retail automation platform comprising:
(a) reading, by a first card reader disposed adjacent a first access point into a first browsing area of a retail store, a first card provided by a first customer;
(b) opening, based on the reading of the first card, the first access point to the first browsing area of the retail store;
(c) displaying, to the first customer via a first touchscreen display disposed in the first browsing area, first information regarding a product stored in a warehouse area of the retail store;
(d) receiving, from the first customer via the first touchscreen display, input corresponding to selection of the product;
(e) reading, by a second card reader disposed in the first browsing area, a second card provided by the first customer, and effecting payment for the product utilizing the read second card;
(f) automatically effecting movement of, via robotic apparatus disposed at the retail store, one of the product from the warehouse area of the retail store to a dispensing area of the first browsing area of the retail store;
(g) updating, from a location remote from the retail store via an electronic interface associated with the retail store, information associated with the product;
(h) reading, by a third card reader disposed adjacent a second access point into a second browsing area of the retail store, a third card provided by a second customer;
(i) opening, based on the reading of the third card, the second access point to the second browsing area of the retail store;
(j) displaying, to the second customer via a second touchscreen display disposed in the second browsing area, second information regarding the product, the second information including the one or more updates to information associated with the product;
(k) receiving, from the second customer via the second touchscreen display, input corresponding to selection of the product;
(l) reading, by a fourth card reader disposed in the second browsing area, a fourth card provided by the second customer, and effecting payment for the product utilizing the read fourth card; and
(m) automatically effecting movement of, via robotic apparatus disposed at the retail store, one of the product from the warehouse area of the retail store to a dispensing area of the second browsing area of the retail store.

104. A method for providing a retail automation platform comprising:
(a) reading, by a first card reader disposed adjacent a first access point into a first browsing area of a retail store, a first card provided by a first customer;
(b) opening, based on the reading of the first card, the first access point to the first browsing area of the retail store;
(c) displaying, to the first customer via a first touchscreen display disposed in the first browsing area, first information regarding a product stored in a warehouse area of the retail store, the first information including a first price;
(d) receiving, from the first customer via the first touchscreen display, input corresponding to selection of the product;
(e) reading, by a second card reader disposed in the first browsing area, a second card provided by the first customer, and effecting payment for the product utilizing the read second card;
(f) automatically effecting movement of, via robotic apparatus disposed at the retail store, one of the product from the warehouse area of the retail store to a dispensing area of the first browsing area of the retail store;
(g) updating, from a location remote from the retail store via an electronic interface associated with the retail store, a price associated with the product;
(h) reading, by a third card reader disposed adjacent a second access point into a second browsing area of the retail store, a third card provided by a second customer;
(i) opening, based on the reading of the third card, the second access point to the second browsing area of the retail store;
(j) displaying, to the second customer via a second touchscreen display disposed in the second browsing area, second information regarding the product, the second information including a second price representing the updated price that is different than the first price;
(k) receiving, from the second customer via the second touchscreen display, input corresponding to selection of the product;
(l) reading, by a fourth card reader disposed in the second browsing area, a fourth card provided by the second customer, and effecting payment for the product utilizing the read fourth card; and
(m) automatically effecting movement of, via robotic apparatus disposed at the retail store, one of the product from the warehouse area of the retail store to a dispensing area of the second browsing area of the retail store.

105. A method for providing a retail automation platform comprising:
(a) displaying, to a customer via a touchscreen display disposed at a lounge of a retail station, information regarding a plurality of products stored in a storage area;
(b) receiving, from the customer via the touchscreen display, input corresponding to selection of a selected product of the plurality of products;
(c) reading, by a card reader disposed at the retail station, a card provided by the customer, and effecting payment for the selected product utilizing the read card;
(d) automatically effecting movement of, via robotic apparatus, the selected product from the storage area to a dispensing area of the retail station.

106. A retail station comprising:
(a) a storage area storing a plurality of products;
(b) a lounge area comprising comfortable seating;
(c) an access point configured to selectively provide access to the lounge area;
(d) a first reader disposed adjacent the access point configured to allow access to the lounge area via the access point;
(e) a touchscreen display disposed within the lounge area configured to present information regarding the plurality of products to a user in the lounge area and allow the user to select one of the products for purchase;
(f) a second reader disposed adjacent the touchscreen display configured to allow the user to pay for the selected product; and
(g) robotic components configured to, based on payment for the selected product, move the selected product from the storage area to a dispensing box in the lounge area.

107. The retail station of element 106, wherein the retail station is located at an airport.

108. The retail station of element 106, wherein the retail station is located at a hotel.

109. The retail station of element 106, wherein the retail station is located at a retail store.

110. The retail station of element 106, wherein the retail station is located at a shopping mall.

111. The retail station of element 106, wherein the access point comprises a sliding door.

112. The retail station of element 106, wherein the access point comprises a sliding glass door.

113. The retail station of element 106, wherein the access point comprises glass.

114. The retail station of element 106, wherein the robotic components comprise a robotic arm.

115. The retail station of element 106, wherein the robotic components comprise a movable tray.

116. The retail station of element 106, wherein the robotic components comprise an elevator.

117. A system comprising:
(a) a storage area storing a plurality of products;
(b) a browsing area;
(c) an access point configured to selectively provide access to the browsing area;
(d) a first reader disposed adjacent the access point configured to allow access to the lounge area via the access point;
(e) a touchscreen display disposed within the lounge area configured to present information regarding the plurality of products to a user in the lounge area and allow the user to select one of the products for purchase;
(f) a second reader disposed adjacent the touchscreen display configured to allow the user to pay for the selected product; and
(g) robotic components configured to, based on payment for the selected product, move the selected product from the storage area to a dispensing box in the lounge area.

118. A retail station comprising:
(a) a storage area storing a plurality of products;
(b) a lounge area comprising comfortable seating;
(c) an access point configured to selectively provide access to the lounge area;
(d) a first reader disposed adjacent the access point configured to allow access to the lounge area via the access point;
(e) a touchscreen display disposed within the lounge area configured to present information regarding the plurality of products to a user in the lounge area and allow the user to select one of the products for purchase;
(f) a second reader disposed adjacent the touchscreen display configured to allow the user to pay for the selected product; and
(g) robotic components configured to, based on payment for the selected product, move the selected product from the storage area to a dispensing area in the lounge area;
(h) one or more computer readable medium containing computer executable instructions for performing a method comprising:
   (i) reading, by the first reader, a first card provided by a customer;
   (ii) opening, based on the reading of the first card, the access point of the retail station;
   (iii) displaying, to the customer via the touchscreen display, information regarding products stored in the storage area;
   (iv) receiving, from the customer via the touchscreen display, input corresponding to selection of a selected product of the plurality of products;
   (v) reading, by the second reader, a second card provided by the customer, and effecting payment for the selected product utilizing the read second card;
   (vi) automatically effecting movement of, via the robotic components, the selected product from the storage area to the dispensing area.

119. One or more non-transitory computer readable mediums containing computer executable instructions configured to perform a method comprising:
(a) reading, by a first card reader disposed proximate an access point to a retail station, a first card provided by a customer;
(b) opening, based on the reading of the first card, the access point to the retail station;
(c) displaying, to the customer via a touchscreen display disposed at the retail station, information regarding a plurality of products stored in a storage area;
(d) receiving, from the customer via the touchscreen display, input corresponding to selection of a selected product of the plurality of products;
(e) reading, by a second card reader disposed at the retail station, a second card provided by the customer, and effecting payment for the selected product utilizing the read second card;
(f) automatically effecting movement of, via robotic apparatus, the selected product from the storage area to a dispensing area of the retail station.

119. One or more non-transitory computer readable mediums containing computer executable instructions configured to perform a disclosed method.

120. A method for providing a retail automation platform comprising:
(a) displaying, to a customer via a touchscreen display disposed in a retail store, information regarding a plurality of products stored in a warehouse area of the retail store;
(b) receiving, from the customer via the touchscreen display, input corresponding to selection of a selected product of the plurality of products;
(c) printing, by a printer disposed adjacent the touchscreen display, a slip comprising a barcode;
(d) reading, by a first reader disposed at the retail store adjacent an access point to a first retail station, a first card provided by the customer or the barcode printed on the slip;
(e) opening, based on the reading of the first card or the barcode, the access point to the first retail station of the retail store;
(f) reading, at the first retail station, the barcode that was printed on the slip;
(g) reading, at the first retail station, a second card provided by the customer, and effecting payment for the selected product utilizing the read second card; and
(h) automatically effecting movement of, via robotic apparatus disposed at the retail store, the selected product from the warehouse area of the retail store to a dispensing area at the first retail station of the retail store.

121. A method for providing a retail automation platform comprising:
(a) displaying, to a customer via a touchscreen display disposed in a retail store, information regarding a plurality of products stored in a warehouse area of the retail store;
(b) receiving, from the customer via the touchscreen display, input corresponding to selection of a selected product of the plurality of products;
(c) printing, by a printer disposed adjacent the touchscreen display, a slip comprising an identifier of a cart;
(d) reading, by a first card reader disposed at the retail store adjacent an access point to a first retail station, a first card provided by the customer;
(e) opening, based on the reading of the first card, the access point to the first retail station of the retail store;
(f) receiving, via a microphone disposed at the first retail station, voice input corresponding to the identifier of the cart that was printed on the slip;
(g) reading, by a second card reader disposed at the first retail station, a second card provided by the customer, and effecting payment for the selected product utilizing the read second card; and
(h) automatically effecting movement of, via robotic apparatus disposed at the retail store, the selected product from the warehouse area of the retail store to a dispensing area at the first retail station of the retail store.

### IV. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Although very narrow claims are presented herein, it should be recognized the scope of this disclosure is much broader than presented by the claims. It is intended that broader claims will be submitted in an application that claims the benefit of priority from this application.

The following is claimed:

1. A method for providing a retail automation platform comprising:
displaying, to a customer via a touchscreen display disposed at a lounge of a retail station, information regarding a plurality of products stored in a storage area of the retail station;
receiving, from the customer via the touchscreen display, input corresponding to selection of a selected product of the plurality of products;
reading, by a card reader disposed at the retail station, a card provided by the customer;
effecting payment for the selected product utilizing the read card; and
automatically effecting movement of, via robotic apparatus, the selected product from the storage area to a dispensing area of the retail station.

2. The method of claim 1, wherein the dispensing area is located within the lounge of the retail station.

3. The method of claim 1, wherein the lounge comprises at least one of the following: one or more pieces of comfortable furniture, a couch, one or more comfortable chairs, and one or more speakers.

4. The method of claim 1, wherein automatically effecting movement of, via robotic apparatus, the selected product from the storage area of the retail station to a dispensing area of the retail station comprises movement of the selected product via a robotic arm.

5. The method of claim 1, wherein automatically effecting movement of, via robotic apparatus, the selected product from the storage area of the retail station to a dispensing area of the retail station comprises moving a movable tray.

6. The method of claim 1, wherein automatically effecting movement of, via robotic apparatus, the selected product from the storage area of the retail station to a dispensing area of the retail station comprises use of an elevator which receives the product and facilitates its movement to the dispensing area of the browsing area.

7. The method of claim 1, wherein displaying, to the customer via a touchscreen display, information regarding a plurality of products stored in a storage area comprises displaying at least one of the following: at least one video, at least one image, at least one photograph, and a three-dimensional model of a product that the customer can rotate using the touchscreen display.

8. The method of claim 1, wherein displaying, to the customer via a touchscreen display, information regarding a plurality of products stored in a storage area comprises displaying a written description of a product.

9. The method of claim 1, further comprising capturing, via a surveillance camera, video of the retail station.

10. The method of claim 9, further comprising transmitting the captured video to a remote location.

11. A method for providing a retail automation platform comprising:
reading, by a first card reader disposed proximate an access point to a retail station, a first card provided by a customer;
opening, based on the reading of the first card, the access point to the retail station;
displaying, to the customer via a touchscreen display disposed at the retail station, information regarding a plurality of products stored in a storage area;
receiving, from the customer via the touchscreen display, input corresponding to selection of a selected product of the plurality of products;
reading, by a second card reader disposed at the retail station, a second card provided by the customer;
effecting payment for the selected product utilizing the read second card; and
automatically effecting movement of, via robotic apparatus, the selected product from the storage area to a dispensing area of the retail station.

12. The method of claim 11, wherein automatically effecting movement of, via robotic apparatus, the selected product from the storage area of the retail station to a dispensing area of the retail station comprises moving of the selected product via a robotic arm.

13. The method of claim 11, wherein automatically effecting movement of, via robotic apparatus, the selected product from the storage area of the retail station to a dispensing area of the retail station comprises moving a movable tray.

14. The method of claim 11, wherein automatically effecting movement of, via robotic apparatus, the selected product from the storage area of the retail station to a dispensing area of the retail station comprises use of an elevator which receives the product and facilitates its movement to the dispensing area of the browsing area.

15. The method of claim 11, wherein displaying, to the customer via a touchscreen display, information regarding a plurality of products stored in a storage area comprises displaying at least one of the following: at least one video, at least one image, at least one photograph, and a three-dimensional model of a product that the customer can rotate using the touchscreen display.

16. The method of claim 11, wherein displaying, to the customer via a touchscreen display, information regarding a plurality of products stored in a storage area comprises displaying a written description of a product.

17. The method of claim 11, wherein the method further includes capturing, via a surveillance camera, video of the retail station.

18. The method of claim 11, wherein the retail station comprises a lounge in proximity to the dispensing area.

19. The method of claim 11, wherein the lounge comprises at least one of the following: one or more pieces of comfortable furniture, a couch, one or more comfortable chairs, and one or more speakers.

20. A method for providing a retail automation platform comprising:
providing, to a customer via first device located remotely from a retail station, information regarding a plurality of products stored in a warehouse area of the retail store;
receiving, from the customer via the first device, input corresponding to selection of a selected product of the plurality of products;
saving the costumer's selection;
reading, by a first card reader disposed at the retail station, a first card provided by the customer;
opening, based on the reading of the first card, the access point to the retail station;
retrieving the saved customer's selection; and
automatically effecting movement of, via robotic apparatus disposed at the retail store, the selected product from the warehouse area of the retail store to a dispensing area at the first retail station of the retail store.
